(19) United States
(12) Patent Application Publication
(10) Pub. No.: US 2025/0266543 A1
(43) Pub. Date: Aug. 21, 2025

(54) BATTERY CELL, BATTERY MODULE, AND BATTERY CELL MANUFACTURING METHOD

(71) Applicant: TOYOTA JIDOSHA KABUSHIKI KAISHA, Aichi-ken (JP)

(72) Inventor: Takumi TANAKA, Toyota-shi (JP)

(21) Appl. No.: 19/021,167

(22) Filed: Jan. 15, 2025

(30) Foreign Application Priority Data
Feb. 20, 2024 (JP) 2024-023400

(51) Int. Cl. H01M 50/186; H01M 50/103; H01M 50/198; H01M 50/533

(52) U.S. Cl. CPC H01M 50/186; H01M 50/103; H01M 50/198; H01M 50/533

(57) ABSTRACT

A battery cell includes: an electrode assembly in which positive electrodes and negative electrodes are alternately stacked in a first direction; a first current collector unit connected to at least one of the positive electrodes; a second current collector unit connected to at least one of the negative electrodes; and an exterior case accommodating the electrode assembly, the first current collector unit, and the second current collector unit. The exterior case includes a first casing body and a second casing body. At least a portion of the first current collector unit is located between the first casing body and the electrode assembly in the first direction and is electrically connected to the first casing body. At least a portion of the second current collector unit is located between the second casing body and the electrode assembly in the first direction, and is electrically connected to the second casing body.

### CROSS REFERENCE TO RELATED APPLICATIONS

This nonprovisional application is based on Japanese Patent Application No. 2024-023400 filed on Feb. 20, 2024 with the Japan Patent Office, the entire content of which is hereby incorporated by reference.

### BACKGROUND

### Field

The present disclosure relates to a battery cell, a battery module, and a battery cell manufacturing method.

### Description of the Background Art

Conventionally, various battery cells are known. As such a battery cell, for example, Japanese Patent Laying-Open No. 2005-310618 discloses a nonaqueous electrolyte secondary battery. The nonaqueous electrolyte secondary battery includes a group of electrode plates obtained by winding into a spiral shape, via a separator, a positive plate having an active material deposited on a band current collector and a negative plate having an active material deposited on a band current collector. The group of electrode plates and a nonaqueous electrolyte are inserted in a metal exterior case. The outermost periphery of the group of electrode plates is formed of a positive current collector that has no active material deposited thereon. The positive current collector is in contact with the inner wall of the exterior case.

### SUMMARY

In the battery cell disclosed in Japanese Patent Laying-Open No. 2005-310618, the negative-current collector unit (the negative current collector) is not in contact with the exterior case. Therefore, there is still room to further improve the volume efficiency.

The present disclosure is to provide a battery cell having an increased volume efficiency, a battery module including the battery cell, and a method of manufacturing the battery cell.

According to a certain aspect of the present disclosure, a battery cell includes: an electrode assembly in which positive electrodes and negative electrodes are alternately stacked in a first direction; a first current collector unit connected to at least one of the positive electrodes; a second current collector unit connected to at least one of the negative electrodes; and an exterior case accommodating the electrode assembly, the first current collector unit, and the second current collector unit. The exterior case includes a first casing body and a second casing body. At least a portion of the first current collector unit is located between the first casing body and the electrode assembly in the first direction and is electrically connected to the first casing body. At least a portion of the second current collector unit is located between the second casing body and the electrode assembly in the first direction, and is electrically connected to the second casing body.

With such a configuration, the first current collector unit can cause the first casing body of the exterior case to function as a terminal for the positive electrodes. The second current collector unit can cause the second casing body of the exterior case to function as a terminal for the negative electrodes.

Furthermore, a portion of the first current collector unit located between the first casing body and the stacked electrode assembly in the first direction is connected to the first casing body. A portion of the second current collector unit located between the cover and the stacked electrode assembly in the first direction is connected to the second casing body. Accordingly, the first current collector unit and the second current collector unit be brought into contact with the exterior case, while being separated from each other in the first direction.

Therefore, according to the battery cell, the volumetric efficiency can be increased, as compared to a battery cell configuration in which only one of the current collector unit for the positive electrodes and the current collector unit for the negative electrodes is in contact with the exterior case.

Preferably, the first casing body has a first base connected to the at least a portion of the first current collector unit, and a first side wall extending from an outer periphery of the first base in a first orientation of the first direction, the first orientation pointing toward the electrode assembly. The second casing body has a second base opposite the first base and connected to the at least a portion of the second current collector unit, and a second side wall extending from an outer periphery of the second base in a second orientation opposite the first orientation. The first side wall and the second side wall partially overlap, as viewed in a second direction perpendicular to the first direction.

With such a configuration, stacked electrode assembly, the first current collector unit, the second current collector unit, and the insulating material can certainly be sealed in the exterior case.

Preferably, an insulating material is loaded between the first side wall portion and the second side wall portion.

With such a configuration, a short circuit can be prevented from occurring between the first casing body and the second casing body of the exterior case.

Preferably, the first current collector unit includes a plurality of first current-collector foils which are each connected to a different positive electrode among the positive electrodes. The first current-collector foils each have a first part extending from the positive electrode in a direction toward the first base, and a second part which continues to the first part and extends in parallel to the first base between the first base and the electrode assembly. The second part is electrically connected to the first casing body and opposite the negative electrode in the first direction. The second part and the negative electrode opposite the second part in the first direction are insulated from each other.

With such a configuration, a short circuit can be prevented from occurring between the first current collector unit and the negative electrode opposite a portion of the first current collector unit in the first direction.

Preferably, the second current collector unit includes a plurality of second current-collector foils which are each connected to a different negative electrode among the negative electrodes. The second current-collector foils each have a first part extending from the negative electrode in a direction toward the second base, and a second part which continues to the first part and extends in parallel to the second base between the second base and the electrode assembly. The second part is electrically connected to the second casing body and opposite the positive electrode in the first direction. The second part and the positive electrode opposite the second part in the first direction are insulated from each other.

With such a configuration, a short circuit can be prevented from occurring between the second current collector unit and the positive electrode opposite a portion of the second current collector unit in the first direction.

Preferably, the electrode assembly further includes a separator layer between the positive electrode and the negative electrode, the separator layer including a solid electrolyte.

With such a configuration, no injection of the electrolyte solution in the exterior case is required. Thus, the electrode assembly can be subjected to discharge and charge tests prior to be accommodated into exterior case.

Preferably, one of the first casing body and the second casing body is a main unit of the exterior case and the other one of the first casing body and the second casing body is a cover of the exterior case.

With such a configuration, one of the first casing body and the second casing body functioning as the main unit is put on the other one of the first casing body and the second casing body, thereby the electrode assembly being accommodated in the exterior case.

According to another aspect of the present disclosure, the battery module includes a plurality of battery cells, including the above-described battery cell, and the plurality of battery cells are stacked in the first direction.

With such a configuration, the volumetric efficiency of the battery cell can be improved, thereby improved the volumetric efficiency of the battery module.

According to still another aspect of the present disclosure, a battery cell manufacturing method includes: mounting a battery cell having: an electrode assembly in which positive electrodes and negative electrodes are alternately stacked in a first direction; a first current collector unit connected to at least one of the positive electrodes; and a second current collector unit connected to at least one of the negative electrodes so that the first current collector unit is in contact with a first casing body of an exterior case of the battery cell in the first direction; moving the first casing body and a second casing body of the exterior case relative to each other so that the second current collector unit is in contact with the second casing body in the first direction; and securing one of the first casing body and the second casing body to the other one of the first casing body and the second casing body.

With such a configuration, a battery cell having a high volumetric efficiency can be manufactured.

Preferably, the first casing body has a first base connected to the at least a portion of the first current collector unit, and a first side wall extending from an outer periphery of the first base in a first orientation of the first direction, the first orientation pointing toward the electrode assembly. The second casing body has a second base opposite the first base and connected to the at least a portion of the second current collector unit, and a second side wall extending from an outer periphery of the second base in a second orientation opposite the first orientation. The first side wall and the second side wall partially overlap, as viewed in a second direction perpendicular to the first direction. The battery cell manufacturing method further include loading an insulating material between the first side wall and the second side wall.

With such a configuration, the second casing body and the first casing body of the exterior case can be insulated from each other. Therefore, a short circuit can be prevented from occurring between the second casing body and the first casing body.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a battery cell.

FIG. 2 is a diagram showing a positive-current collector unit and a negative-current collector unit.

FIG. 3 is a diagram showing a battery module.

FIG. 4 is a diagram for illustrating a method for manufacturing the battery cell.

FIG. 5 is a diagram for illustrating a repair method for the battery cell.

FIG. 6 is a diagram illustrating a variation of the battery cell.

FIG. 7 is a diagram illustrating another variation of the battery cell.

FIG. 8 is a diagram illustrating still another variation of the battery cell.

FIG. 9 is a diagram illustrating still another variation of the battery cell.

FIG. 10 is a diagram illustrating still another variation of the battery cell.

FIG. 11 is a diagram illustrating still another variation of the battery cell.

FIG. 12 is a diagram showing a battery cell according to another embodiment.

FIG. 13 is a diagram showing a battery cell according to still another embodiment.

FIG. 14 is a diagram showing a battery cell according to still another embodiment.

FIG. 15 is a diagram showing a battery cell according to still another embodiment.

FIG. 16 is a diagram showing a battery cell according to still another embodiment.

FIG. 17 is a diagram showing an electrode unit.

### DESCRIPTION OF THE PREFERRED EMBODIMENTS

Hereinafter, embodiments according to the present disclosure will be described, with reference to the accompanying drawings. In the following description, the same reference signs refer to the same members. Their names and functionalities are also the same. Therefore, detailed description thereof will not be repeated.

Various battery cells and battery modules including the battery cells (described below) are mounted on hybrid electric vehicles capable of traveling using a mechanical power of at least one of the motor or the engine, or electric-powered vehicles such as electric vehicles that travel using a driving force obtained from electrical energy.

In the following, the terms upward, downward, top, and bottom are based on positions of a battery cell during manufacture. The position of the battery cell when mounted on an electric-powered vehicle is not necessarily be the same as that during manufacture.

### Embodiment 1

### (1. Battery Cell)

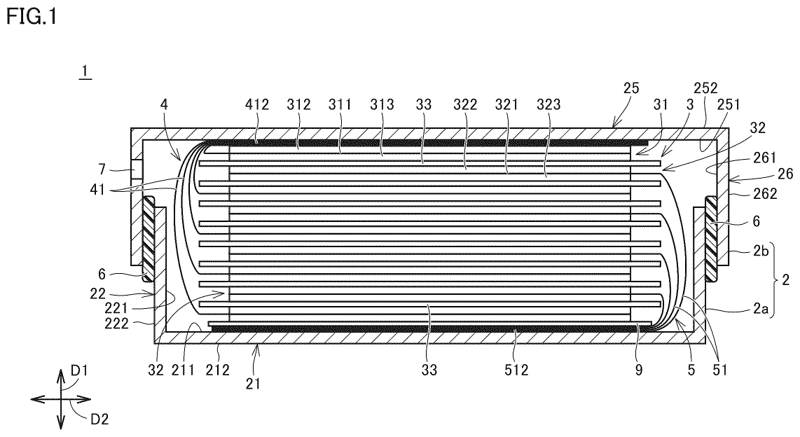

FIG. 1 is a diagram showing a battery cell according to the present embodiment. As shown in FIG. 1, a battery cell 1 includes an exterior case 2, a stacked electrode assembly 3, a positive-current collector unit 4, a negative-current collector unit 5, an insulating material 6, and an insulating sheet 9. Note that, for convenience of illustration, FIG. 1 shows cross sections of exterior case 2 and insulating material 6.

Exterior case 2 accommodates stacked electrode assembly 3, positive-current collector unit 4, and negative-current collector unit 5. Exterior case 2 includes a main unit 2a and a cover 2b. Main unit 2a has a bottom 21 and a side wall portion 22 projecting upward from the outer periphery of bottom 21. Cover 2b has a top 25 opposite the bottom 21, and a side wall portion 26 projecting downward from the outer periphery of top 25.

Note that one of main unit 2a and cover 2b corresponds to a “first casing body” according to the present disclosure, and the other corresponds to a “second casing body” according to the present disclosure. One of bottom 21 and top 25 corresponds to a “first base” according to the present disclosure and the other corresponds to a “second base” according to the present disclosure.

Cover 2b is put on main unit 2a to cover a portion of side wall portion 22 of main unit 2a. Side wall portion 22 and side wall portion 26 partially overlap as viewed from D2 direction perpendicular to D1 direction which is the direction in which stacked electrode assembly 3 is stacked.

Exterior case 2, typically, has a generally parallelepiped shape. However, the shape of exterior case 2 is not limited thereto. In this example, exterior case 2 is filled with an electrolyte solution. The interior of exterior case 2 is in vacuum.

Bottom 21 of main unit 2a has an inner wall surface 211 and an outer wall surface 212. Side wall portion 22 of main unit 2a has an inner wall surface 221 and an outer wall surface 222. Inner wall surface 211 and inner wall surface 221 are wall surfaces on the stacked electrode assembly 3 side.

Top 25 of cover 2b has an inner wall surface 251 and an outer wall surface 252. Side wall portion 26 of cover 2b has an inner wall surface 261 and an outer wall surface 262. Inner wall surface 251 and inner wall surface 261 are wall surfaces on the stacked electrode assembly 3 side. Inner wall surface 251 is opposite the inner wall surface 211 of bottom 21.

There is a gap between side wall portion 22 of main unit 2a and side wall portion 26 of cover 2b. Specifically, there is a gap between outer wall surface 222 of side wall portion 22 and inner wall surface 261 of side wall portion 26. More specifically, outer wall surface 222 of main unit 2a and inner wall surface 261 of cover 2b partially oppose to each other.

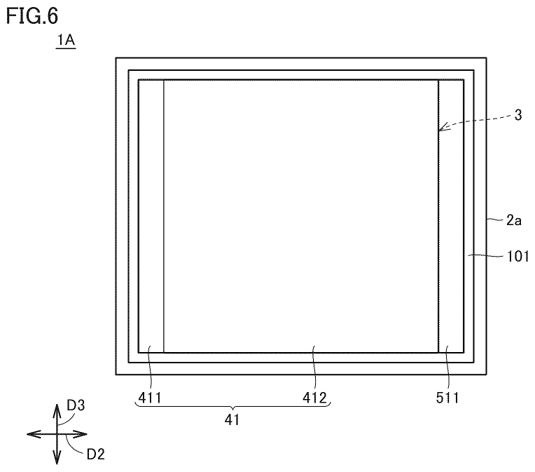

Insulating material 6 is loaded between side wall portion 22 and side wall portion 26. Insulating material 6 is loaded between outer wall surface 222 and inner wall surface 261. Insulating material 6 is loaded in a region (gap) where outer wall surface 222 and inner wall surface 261 oppose to each other. Insulating material 6 insulates main unit 2a and cover 2b from each other. Insulating material 6 allows cover 2b to be secured to main unit 2a. Insulating material 6 restricts the movement of cover 2b toward main unit 2a in D1 direction. Insulating material 6 further restricts the movement of cover 2b toward main unit 2a in D2 direction and a direction (see D3 direction of FIG. 6) perpendicular to D1 direction and D2 direction.

Insulating material 6, in this example, is a thermoplastic resin. However, insulating material 6 is not limited thereto, and may be an adhesive, a thermosetting resin, or a highly viscous fluid. Insulating material 6 may contain insulative particles. Containing the insulative particles can more certainly prevent the contact between main unit 2a and cover 2b.

Cover 2b is provided with a gas-draining valve 7. Specifically, side wall portion 26 is provided with valve 7. Valve 7 allows a gas, generated by stacked electrode assembly 3, to be drained out of exterior case 2.

Stacked electrode assembly 3 includes multiple positive electrodes 31, multiple negative electrodes 32, and multiple separators 33. In stacked electrode assembly 3, two types of electrodes having different polarities (positive electrode 31 and negative electrode 32) are alternately stacked in D1 direction via separator 33. Cover 2b and main unit 2a apply a constraint force (a pressure) to stacked electrode assembly 3 in D1 direction. Specifically, top 25 and bottom 21 apply the constraint force to stacked electrode assembly 3 in D1 direction.

In this example, an end of stacked electrode assembly 3 on the top 25 side is a positive electrode 31. An end of stacked electrode assembly 3 on the bottom 21 side is also a positive electrode 31. Insulating sheet 9 is stacked on the end (positive electrode 31) on the bottom 21 side. In the following, positive electrode 31 that is the end on the top 25 side will also be referred to as a “top-side positive electrode 31.” Positive electrode 31 that is the end on the bottom 21 side will also be referred to as a “bottom-side positive electrode 31.”

Each positive electrode 31 includes a current-collector foil 311 and active materials 312 and 313 coating the opposing surfaces of current-collector foil 311. Active material 312 is closer to the top 25 side than active material 313 is.

Each negative electrode 32 includes a current-collector foil 321 and active materials 322 and 323 coating the opposing surfaces of current-collector foil 321. Active material 322 is closer to the top 25 side than active material 323 is.

Each separator 33 is sandwiched between positive electrode 31 and negative electrode 32. Each separator 33 is in contact with active material 313 (or active material 312) and active material 322 (or active material 323). The electrolyte solution penetrates each separator 33.

Each positive electrode 31, each negative electrode 32, each separator 33, and insulating sheet 9 expand in D2 direction and D3 direction (see FIG. 6).

### (2. Positive-Current Collector Unit and Negative-Current Collector Unit)

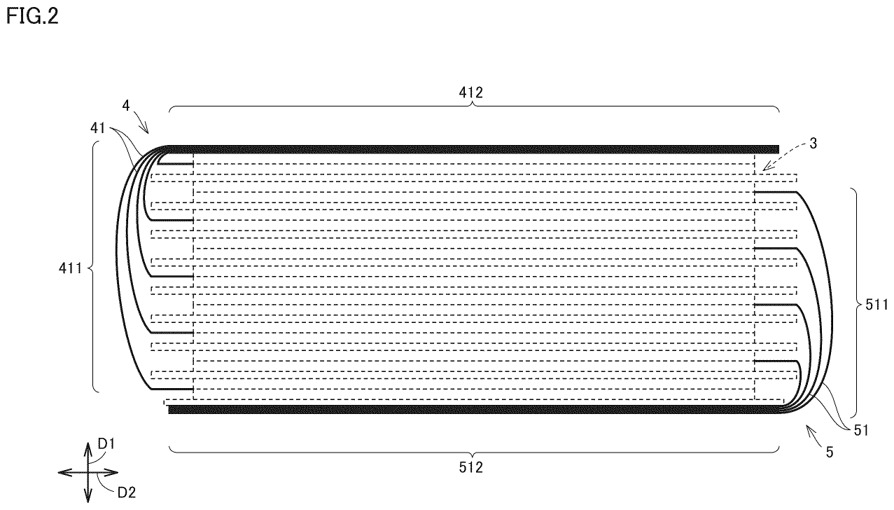

FIG. 2 is a diagram showing positive-current collector unit 4 and negative-current collector unit 5. In the following, positive-current collector unit 4 and negative-current collector unit 5 will be described with reference to FIGS. 1 and 2.

Positive-current collector unit 4 includes multiple current-collector foils 41 that are connected to different positive electrodes 31. In this example, positive-current collector units 4 include five current-collector foils 41. Each current-collector foil 41 has a part 411 extending from positive electrode 31 toward top 25, and a part 412 that continues to part 411 and extends in parallel to top 25 between top 25 and stacked electrode assembly 3. Therefore, positive-current collector unit 4 has five parts 411 and five parts 412.

Parts 412 of current-collector foils 41 are collected and stacked in D1 direction. In this example, parts 412 of five current-collector foils 41 are stacked in D1 direction in intimate physical contact with each other. Parts 412 may be or may not be welded together. Parts 411 differ for each current-collector foil 41. Parts 412 of current-collector foils 41, in contrast, are the same in this example.

Parts 412 are located between cover 2b and stacked electrode assembly 3 in D1 direction. Parts 412 are electrically connected to cover 2b. Parts 412 of current-collector foils 41 are connected to top 25 of cover 2b. Specifically, one part 412 is in contact with inner wall surface 251 of top 25 with a pressure being applied to the part 412 in D1 direction. Parts 412 are opposite the top-side positive electrode 31 in D1 direction. Parts 412 are placed on top-side positive electrode 31, without being insulated from top-side positive electrode 31 of stacked electrode assembly 3. In this manner, parts 412 are electrically connected to cover 2b and opposite the top-side positive electrode 31 of stacked electrode assembly 3 in D1 direction.

In this example, current-collector foil 41 and current-collector foil 311 (FIG. 1) of positive electrode 31 are one piece of foil. In other words, current-collector foil 41 and current-collector foil 311 are formed from one foil. In this example, an area uncoated with active materials 312 and 313 corresponds to current-collector foil 41, and an area coated with active materials 312 and 313 corresponds to current-collector foil 311. Current-collector foil 41 functions as a tab for positive electrode 31. The present disclosure is not limited thereto. Current-collector foil 41 and current-collector foil 311 may be separate components. If current-collector foil 41 and current-collector foil 311 are separate components, a tab portion (an uncoated area) may be provided on current-collector foil 311 for welding current-collector foil 41 to current-collector foil 311.

Negative-current collector unit 5 includes multiple current-collector foils 51 that are connected to different negative electrodes 32. In this example, negative-current collector units 5 include four current-collector foils 51. Each current-collector foil 51 has a part 511 extending from negative electrode 32 toward bottom 21, and a part 512 that continues to part 511 and extends in parallel to bottom 21 between bottom 21 and stacked electrode assembly 3. Therefore, negative-current collector unit 5 has four parts 511 and four parts 512.

Parts 512 of current-collector foils 51 are collected and stacked in D1 direction. In this example, parts 512 of four current-collector foils 51 are stacked in D1 direction in intimate physical contact with each other. Parts 512 may be or may not be welded together. Parts 511 differ for each current-collector foil 51. Parts 512 of current-collector foils 51, in contrast, are the same in this example.

Parts 512 are located between main unit 2a and stacked electrode assembly 3 in D1 direction. Parts 512 are electrically connected to main unit 2a. Parts 512 of current-collector foils 51 are connected to bottom 21 of main unit 2a. Specifically, one part 512 is in contact with inner wall surface 211 of bottom 21 with a pressure being applied to the part 512 in D1 direction. Part 512 are opposite the bottom-side positive electrode 31 in D1 direction. Parts 512 are placed on bottom-side positive electrode 31, while being insulated from bottom-side positive electrode 31 of stacked electrode assembly 3.

In this manner, parts 512 are electrically connected to main unit 2a and opposite the bottom-side positive electrode 31 of stacked electrode assembly 3 in D1 direction. Part 512 and bottom-side positive electrode 31 opposite the part 512 in D1 direction are insulated from each other. Parts 512 and bottom-side positive electrode 31 are insulated from each other by insulating sheet 9.

In this example, current-collector foil 51 and current-collector foil 321 (FIG. 1) of negative electrode 32 are one piece of foil. In other words, current-collector foil 51 and current-collector foil 321 are formed from one foil. In this example, an area uncoated with active materials 322 and 323 corresponds to current-collector foil 51, and an area coated with active materials 322 and 323 corresponds to current-collector foil 321. Current-collector foil 51 functions as a tab for negative electrode 32. The present disclosure is not limited thereto. Current-collector foil 51 and current-collector foil 321 may be separate components. If current-collector foil 51 and current-collector foil 321 are separate components, a tab portion (an uncoated area) may be provided on current-collector foil 321 for welding current-collector foil 51 to current-collector foil 321.

As shown in FIG. 1, cover 2b of exterior case 2 is connected to positive-current collector unit 4. Main unit 2a of exterior case 2 is connected to negative-current collector unit 5. Cover 2b and main unit 2a are insulated from each other by insulating material 6. Accordingly, battery cell 1 can cause cover 2b to function as a positive terminal and main unit 2a to function as a negative terminal.

### (3. Summary of Battery Cell)

(1) Battery cell 1 includes: (i) stacked electrode assembly 3 in which negative electrodes 32 and positive electrodes 31 are alternately stacked in D1 direction; (ii) negative-current collector unit 5 connected to the negative electrodes 32; (iii) positive-current collector unit 4 connected to the positive electrodes 31; and (iv) exterior case 2 accommodating stacked electrode assembly 3, negative-current collector units 5, and positive-current collector units 4. Exterior case 2 includes main unit 2a and cover 2b. Parts 512 of negative-current collector unit 5 are located between main unit 2a and stacked electrode assembly 3 in D1 direction, and are electrically connected to main unit 2a. Parts 412 of positive-current collector unit 4 are located between cover 2b and stacked electrode assembly 3 in D1 direction, and are electrically connected to cover 2b.

With such a configuration, negative-current collector unit 5 can cause main unit 2a of exterior case 2 to function as a negative terminal. Positive-current collector unit 4 can cause cover 2b of exterior case 2 to function as a positive terminal.

Furthermore, negative-current collector unit 5 is connected to main unit 2a by parts 512 located between main unit 2a and stacked electrode assembly 3 in D1 direction. Positive-current collector unit 4 is connected to cover 2b by parts 412 located between cover 2b and stacked electrode assembly 3 in D1 direction. Accordingly, positive-current collector unit 4 and negative-current collector unit 5 can be brought into contact with exterior case 2, while being separated from each other in D1 direction.

Therefore, according to battery cell 1, the volumetric efficiency can be increased, as compared to a battery cell configuration in which only one of the negative-current collector unit and the positive-current collector unit is in contact with the exterior case.

(2) Main unit 2a has bottom 21 connected to parts 512 of negative-current collector unit 5 and side wall portion 22 projecting upward from the outer periphery of bottom 21. Cover 2b has top 25 opposite the bottom 21 and connected to parts 412 of positive-current collector unit 4, and side wall portion 26 projecting downward from the outer periphery of top 25. Side wall portion 22 and side wall portion 26 partially overlap as viewed from D2 direction perpendicular to D1 direction. With such a configuration, stacked electrode assembly 3, positive-current collector unit 4, negative-current collector unit 5, and insulating material 6 can certainly be sealed in exterior case 2.

(3) Insulating material 6 is loaded between side wall 22 and side wall 26. With such a configuration, a short circuit can be prevented from occurring between main unit 2a and cover 2b of exterior case 2.

(4) Negative-current collector unit 5 includes multiple current-collector foils 51 that are connected to different negative electrodes 32. Each current-collector foil 51 has part 511 extending from negative electrode 32 toward bottom 21, and part 512 that continues to part 511 and extends in parallel to bottom 21 between bottom 21 and stacked electrode assembly 3. Parts 512 are electrically connected to main unit 2a and opposite the positive electrode 31 in D1 direction. Parts 512 and positive electrode 31 (i.e., bottom-side positive electrode 31) opposite the parts 512 in D1 direction are insulated from each other. With such a configuration, a short circuit can be prevented from occurring between negative-current collector unit 5 and positive electrode 31 opposite the parts 512 of negative-current collector unit 5 in D1 direction.

(5) Positive-current collector unit 4 includes multiple current-collector foils 41 that are connected to different positive electrodes 31. Each current-collector foil 41 has part 411 extending from positive electrode 31 toward top 25 and part 412 that continues to part 411 and extends in parallel to top 25 between top 25 and stacked electrode assembly 3. Parts 412 are electrically connected to cover 2b.

### (4. Battery Module)

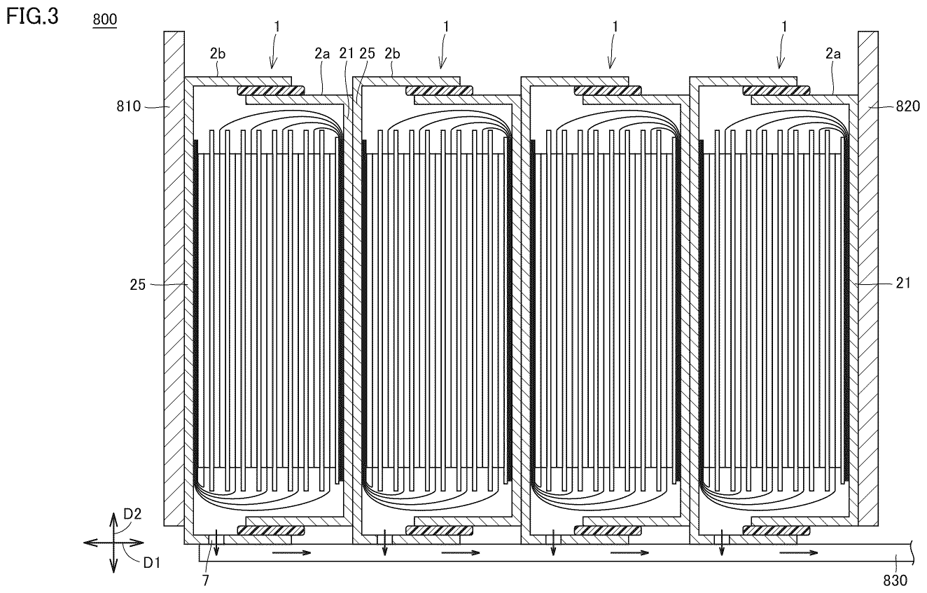

FIG. 3 is a diagram showing a battery module. As shown in FIG. 3, a battery module 800 includes multiple battery cells 1, a positive external terminal 810, a negative external terminal 820, and an exhaust duct 830. In battery module 800, battery cells 1 are connected in series. In this example, four battery cells 1 are stacked in D1 direction.

Note that, in the following, for convenience of illustration, a battery cell 1 on positive external terminal 810 side will also be referred to as a “first battery cell 1.” A battery cell 1 on negative external terminal 820 side will also be referred to as a “fourth battery cell 1.” A battery cell 1 adjacent to first battery cell 1 will also be referred to as a “second battery cell 1.” A battery cell 1 adjacent to fourth battery cell 1 will also be referred to as a “third battery cell 1.”

First battery cell 1 is in contact with positive external terminal 810. Specifically, cover 2b of first battery cell 1 is in contact with positive external terminal 810. More specifically, top 25 of cover 2b is in contact with positive external terminal 810. Main unit 2a of first battery cell 1 is in contact with cover 2b of second battery cell 1. Specifically, bottom 21 of main unit 2a is in contact with top 25 of cover 2b.

Similarly, bottom 21 of main unit 2a of second battery cell 1 is in contact with top 25 of cover 2b of third battery cell 1. Bottom 21 of main unit 2a of third battery cell 1 in contact with top 25 of cover 2b of fourth battery cell 1.

Fourth battery cell 1 is in contact with negative external terminal 820. Specifically, main unit 2a of fourth battery cell 1 is in contact with negative external terminal 820. More specifically, bottom 21 of main unit 2a is in contact with negative external terminal 820.

As such, battery cells 1 are stacked and connected in a manner that main unit 2a of one battery cell 1 and cover 2b of another battery cell 1 are in contact, and battery module 800 is thereby manufactured. Accordingly, battery module 800 having a high volumetric efficiency can be readily manufactured.

Exhaust duct 830 is connected to valves 7 in side walls 26 of covers 2b of exterior cases 2. Exhaust duct 830 covers respective valves 7. Exhaust duct 830 is partially in contact with side wall 26 of cover 2b of each exterior case 2.

Respective valves 7 and exhaust duct 830 allow gases generated by the respective stacked electrode assemblies 3 to be drained out of exterior cases 2. The drained gas is treated by a downstream device to prevent untreated gas from leaking externally.

### (5. Battery Cell Manufacturing Method)

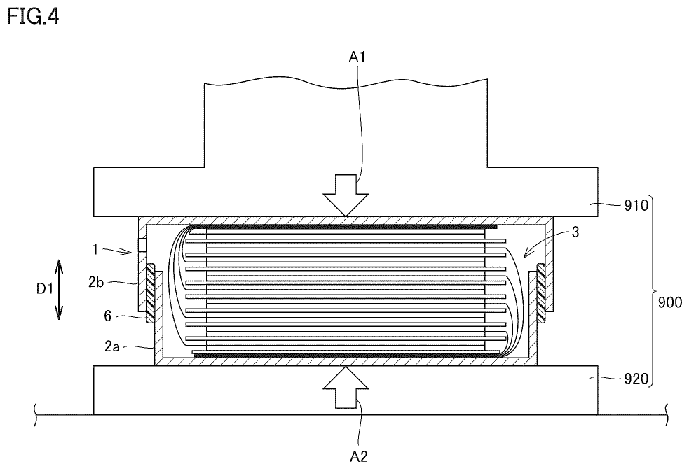

FIG. 4 is a diagram for illustrating a method for manufacturing battery cell 1. As shown in FIG. 4, a pressing machine 900 includes a slide 910 and a bolster 920 disposed immediately below slide 910.

Battery cell 1 having insulating material 6 before being solidified is mounted on bolster 920. Battery cell 1 is stacked on bolster 920 in a manner that the direction (D1) in which the stacked electrode assembly 3 is stacked is the vertical direction. Battery cell 1 is mounted on bolster 920 so that bottom 21 of main unit 2a of exterior case 2 is in contact with bolster 920.

Pressing machine 900 applies a force to battery cell 1 to compress battery cell 1 in orientations indicated by arrows A1 and A2 in D1 direction. Specifically, slide 910 is lowered to apply a force in D1 direction to battery cell 1. Due to this, the force in D1 direction is being applied to stacked electrode assembly 3. In this state, insulating material 6 is solidified. The solidification of insulating material 6 secures cover 2b to main unit 2a. Therefore, even when slide 910 is raised, cover 2b and main unit 2a are allowed to continue to apply the force in D1 direction (a constraint force) to stacked electrode assembly 3. In other words, a surface pressure can be applied to stacked electrode assembly 3.

Specifically, since bolster 920 and slide 910 apply the force in D1 direction to battery cell 1 prior to the solidification of insulating material 6, the load in D1 direction can be prevented from being focused on side wall 26 of cover 2b and side wall 22 of main unit 2a.

The method for manufacturing battery cell 1 includes: a step of mounting, on main unit 2a by a transfer machine (not shown), battery cell 1 having stacked electrode assembly 3, in which negative electrodes 32 and positive electrodes 31 are alternately stacked in D1 direction, negative-current collector unit 5 connected to the negative electrodes 32, the positive electrodes 31 connected to the positive-current collector unit 4, so that negative-current collector unit 5 is brought into contact with exterior case 2 of main unit 2a in D1 direction; and a step of moving cover 2b by the transfer machine so that positive-current collector unit 4 is brought into contact with cover 2b of exterior case 2 in D1 direction. In this example, the movement puts cover 2b on main unit 2a. The method further includes a step of securing cover 2b to main unit 2a. According to such a method, the manufacturing efficiency of battery cell 1 can be enhanced.

In this example, cover 2b is secured to main unit 2a with exterior case 2 being compressed in D1 direction by pressing machine 900 and cover 2b and main unit 2a being insulated from each other. However, depending on component materials of the battery, cover 2b may be secured to main unit 2a as the above, without cover 2b and main unit 2a being insulated from each other. Note that the process of securing cover 2b to main unit 2a is, typically, performed by a machine (not shown).

In the above, cover 2b is put on main unit 2a by moving cover 2b. The present disclosure is not limited thereto. Main unit 2a may be moved, in stead of moving cover 2b. Cover 2b and main unit 2a may be moved. Main unit 2a and cover 2b may be moved relative to each other.

The method further includes a step of loading insulating material 6 between side wall 22 and side wall 26. According to such a method, cover 2b and main unit 2a can be insulated from each other. Thus, a short circuit can be prevented from occurring between cover 2b and main unit 2a.

### (6. Battery Cell Repair Method)

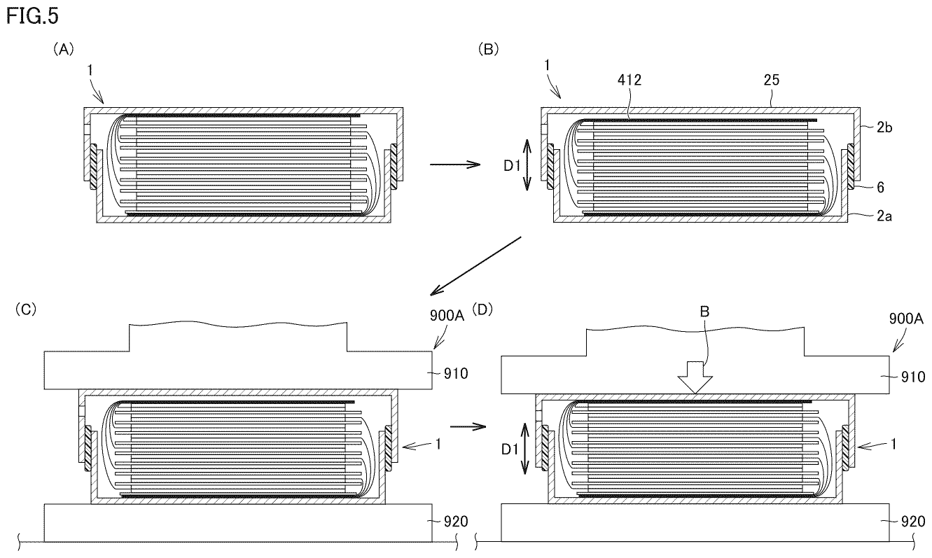

FIG. 5 is a diagram for illustrating a repair method for battery cell 1. The use of battery cell 1 may reduce the thickness of stacked electrode assembly 3. Specifically, the use of battery cell 1 reduces the thickness of stacked electrode assembly 3 in D1 direction, as compared to the initial state illustrated in a state (A) of FIG. 5. When this happens, the force in D1 direction (the constraint force, the surface pressure) applied to stacked electrode assembly 3 ceases to exist, as illustrated in a state (B). Note that, the state (B) illustrates a gap being formed between parts 412 of positive-current collector unit 4 and top 25 of exterior case 2.

In this case, battery cell 1 undergoes the following treatment using a heat press 900A. Battery cell 1 is mounted on bolster 920 of heat press 900A. Next, the slide of heat press 900A is lowered to the location of top 25 of cover 2b, as illustrated in a state (C). In this state, heat is applied to battery cell 1. Specifically, heat is applied to exterior case 2 from at least one of slide 910 and bolster 920. The heat transferred to exterior case 2 is transferred to insulating material 6 as well. As a result, the solidified (cured) insulating material 6 is softened.

With insulating material 6 being softened, slide 910 is lowered further down, as illustrated in a state (D). Specifically, slide 910 is moved in the direction of arrow B. This applies the force in D1 direction to stacked electrode assembly 3. In this state, the application of the heat is ceased and insulating material 6 is solidified. Solidifying, again, insulating material 6 secures cover 2b to main unit 2a. Therefore, even when slide 910 is raised, cover 2b and main unit 2a are allowed to continue to apply the force in D1 direction to stacked electrode assembly 3. In this manner, the surface pressure can be applied to stacked electrode assembly 3, again, by reducing the thickness of exterior case 2 in D1 direction, using heat press 900A. This can recover the performance of battery cell 1.

### <Variations>

In the following, multiple variations of battery cell 1 are described. Similarly to battery cell 1, even these variations can increase the volumetric efficiency, as compared to the battery cell configuration in which only one of the negative-current collector unit and the positive-current collector unit is in contact with the exterior case.

### (Variation 1)

In the above, as shown in FIGS. 1, 2, etc., positive-current collector unit 4 is connected to cover 2b of exterior case 2 and negative-current collector unit 5 is connected to main unit 2a of exterior case 2. However, the present disclosure is not limited thereto. Positive-current collector unit 4 may be connected to main unit 2a of exterior case 2 and negative-current collector unit 5 may be connected to cover 2b of exterior case 2. In this case, the main unit 2a side is the positive electrode of battery cell 1, and the cover 2b side is the negative electrode of battery cell 1.

### (Variation 2)

In stacked electrode assembly 3, the electrodes on the opposing ends of the stack are positive electrodes 31. However, the present disclosure is not limited thereto. Stacked electrode assembly 3 may be configured so that negative electrodes 32 are the opposing ends of the stack.

Alternatively, stacked electrode assembly 3 may be configured so that positive electrode 31 is the end on the main unit 2a side and negative electrode 32 is the end on the cover 2b side. With such a configuration, parts 412 are electrically connected to cover 2b and opposite the negative electrode 32 in D1 direction. Therefore, part 412 and negative electrode 32 opposite the parts 412 in D1 direction are insulated from each other with an insulating sheet (not shown). With such a configuration, a short circuit can be prevented from occurring between positive-current collector unit 4 and negative electrode 32 opposite the parts 412 of positive-current collector unit 4 in D1 direction.

Not limited to the above, stacked electrode assembly 3 may be configured so that negative electrode 32 is the end on the main unit 2a side and positive electrode 31 is the end on the cover 2b side. Even with this configuration, a short circuit may be prevented by appropriately arranging the insulating sheet.

### (Variation 3)

FIG. 6 is a diagram illustrating Variation 3 of battery cell 1. In FIG. 6, for convenience of illustration, cover 2b of exterior case 2 is not shown. As shown in FIG. 6, a battery cell 1A further includes a spacer 101, in addition to exterior case 2, stacked electrode assembly 3, positive-current collector unit 4, negative-current collector unit 5, and insulating material 6. Battery cell 1A differs from battery cell 1 in that the battery cell 1A includes spacer 101.

Spacer 101 is an insulative member. Spacer 101 is disposed between stacked electrode assembly 3 and main unit 2a of exterior case 2. Specifically, spacer 101 is disposed within main unit 2a along inner wall surface 221 (see FIG. 1) of side wall 22 of main unit 2a. Stacked electrode assembly 3 is surrounded by spacer 101. In this example, spacer 101 is in contact with current-collector foil 41 and current-collector foil 51. Specifically, spacer 101 is in contact with part 411 of current-collector foil 41 and part 511 of current-collector foil 51.

With such a configuration, spacer 101 can prevent misalignment of stacked electrode assembly 3 within exterior case 2. Specifically, spacer 101 can prevent stacked electrode assembly 3 from moving in D2 direction and D3 direction within exterior case 2.

### (Variation 4)

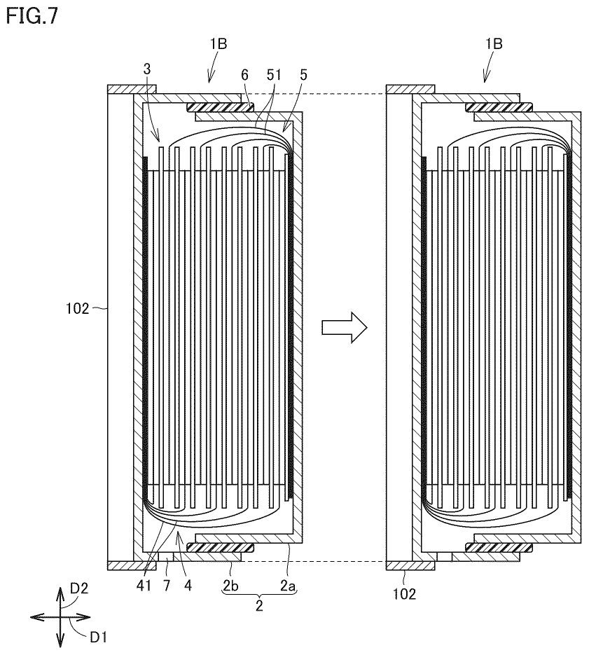

FIG. 7 is a diagram illustrating Variation 4 of battery cell 1. As shown in FIG. 7, a battery cell 1B further includes a positioning frame 102, in addition to exterior case 2, stacked electrode assembly 3, positive-current collector unit 4, negative-current collector unit 5, and insulating material 6. Battery cell 1B differs from battery cell 1 in that the battery cell 1B includes frame 102. Note that FIG. 7 shows a cross section of a portion of frame 102.

Frame 102 extends upward from side wall 26 of cover 2b in D1 direction. Specifically, frame 102 extends upward outer wall surface 262 (see FIG. 1) of side wall 26 in an orientation opposite the orientation toward main unit 2a. Frame 102 projects in D1 direction from top 25. As exterior case 2 is viewed from the cover 2b side in D1 direction, frame 102 has a rectangular frame shape having an opening along the side wall 26.

With such a configuration, misalignment between battery cells 1B can be prevented when stacking battery cells 1B.

### (Variation 5)

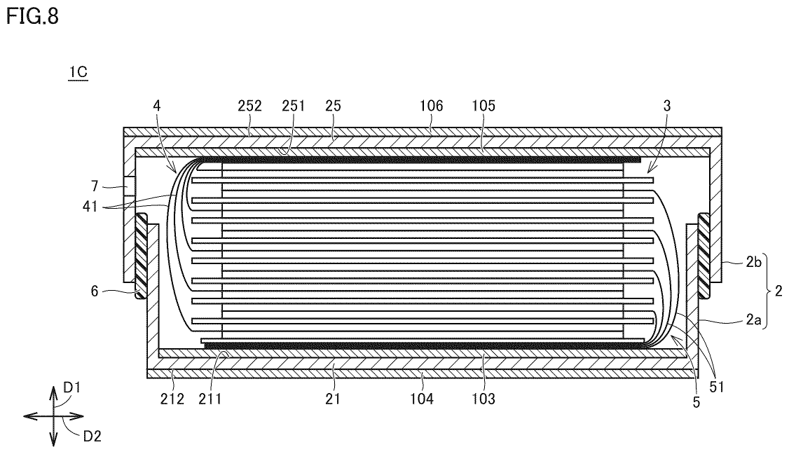

FIG. 8 is a diagram illustrating Variation 5 of battery cell 1. As shown in FIG. 8, similarly to battery cell 1, a battery cell 1C includes exterior case 2, stacked electrode assembly 3, positive-current collector unit 4, negative-current collector unit 5, and insulating material 6. In battery cell 1C, main unit 2a and cover 2b of exterior case 2 are covered with a highly electrically conductive material.

Specifically, inner wall surface 211 of bottom 21 of main unit 2a is covered with a highly conductive metal layer 103. Outer wall surface 212 of bottom 21 is covered with a highly conductive metal layer 104. Similarly, inner wall surface 251 of top 25 is covered with a highly conductive metal layer 105. Outer wall surface 252 of top 25 is covered with a highly conductive metal layer 106. For example, metal layers 103 to 106 may be formed from the same metal.

With such a configuration, the battery module configured of stacked battery cells 1C as shown in FIG. 3 can reduce the electric resistance between adjacent battery cells 1C, as compared to the configuration in which exterior case 2 is not covered with a highly conductive metal layer.

### (Variation 6)

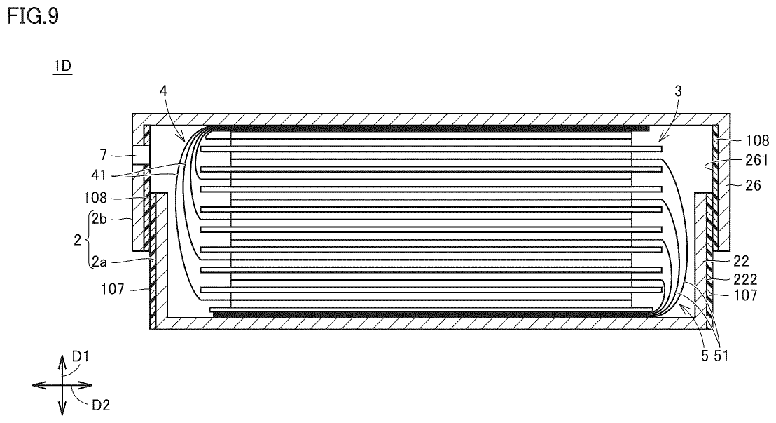

FIG. 9 is a diagram illustrating Variation 6 of battery cell 1. As shown in FIG. 9, a battery cell 1D includes exterior case 2, stacked electrode assembly 3, positive-current collector unit 4, and negative-current collector unit 5. Unlike battery cell 1, battery cell 1D does not include insulating material 6. However, as with battery cell 1, main unit 2a and cover 2b of exterior case 2 of battery cell 1D needs to be insulated. Because of this, battery cell 1D has the following configuration.

For battery cell 1D, side wall 22 of main unit 2a and side wall 26 of cover 2b of exterior case 2 have been previously insulated. Specifically, outer wall surface 222 of side wall 22 is covered with an insulative member 107. Inner wall surface 261 of side wall 26 is covered with an insulative member 108.

With such a configuration, outer wall surface 222 of side wall 22 and inner wall surface 261 of side wall 26 do not come into contact. Therefore, a short circuit can be prevented from occurring between main unit 2a and cover 2b.

As viewed from D2 direction, overlapping area of main unit 2a and cover 2b overlap with insulative members 107 and 108. Owing to this, a short circuit can be better prevented from occurring between main unit 2a and cover 2b, as compared to a configuration without the insulative members.

### (Variation 7)

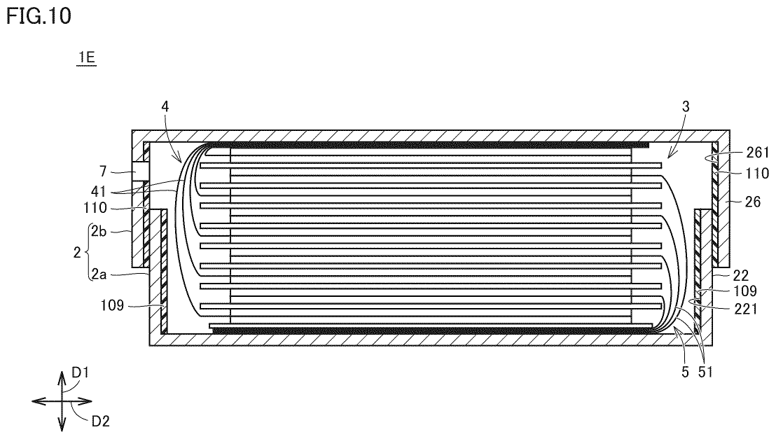

FIG. 10 is a diagram illustrating Variation 7 of battery cell 1. As shown in FIG. 10, a battery cell 1E includes exterior case 2, stacked electrode assembly 3, positive-current collector unit 4, and negative-current collector unit 5. As with battery cell 1D, battery cell 1E does not include insulating material 6.

For battery cell 1E, side wall 22 of main unit 2a and side wall 26 of cover 2b of exterior case 2 have been previously insulated. Specifically, inner wall surface 221 of side wall 22 is covered with an insulative member 109. Inner wall surface 261 of side wall 26 is covered with an insulative member 110.

With such a configuration, member 110 prevents contact between main unit 2a and cover 2b of exterior case 2. Therefore, a short circuit can be prevented from occurring between main unit 2a and cover 2b. Furthermore, member 109 prevents contact between exterior case 2 and stacked electrode assembly 3. Specifically, side wall 22 of exterior case 2 and stacked electrode assembly 3 do not come into contact. Therefore, a short circuit can be prevented from occurring between main unit 2a and stacked electrode assembly 3.

Note that, as with battery cell 1D described above, outer wall surface 222 of side wall 22 of main unit 2a may be previously insulated too. In other words, inner wall surface 221 and outer wall surface 222 of side wall 22 may be previously insulated. Furthermore, outer wall surface 262 of the side wall of cover 2b may be previously insulated. In other words, inner wall surface 261 and outer wall surface 262 of side wall 26 may be insulated.

Not limited to the above, at least one of outer wall surface 222 of side wall 22 and inner wall surface 261 of side wall 26 may be insulated. Preferably, like battery cell 1D, outer wall surface 222 of side wall 22 and inner wall surface 261 of side wall 26 are both insulated.

Preferably, outer wall surfaces 222 and 262 are insulated. With such a configuration, a short circuit can be prevented from occurring between battery cell 1 and an object external to battery cell 1.

### (Variation 8)

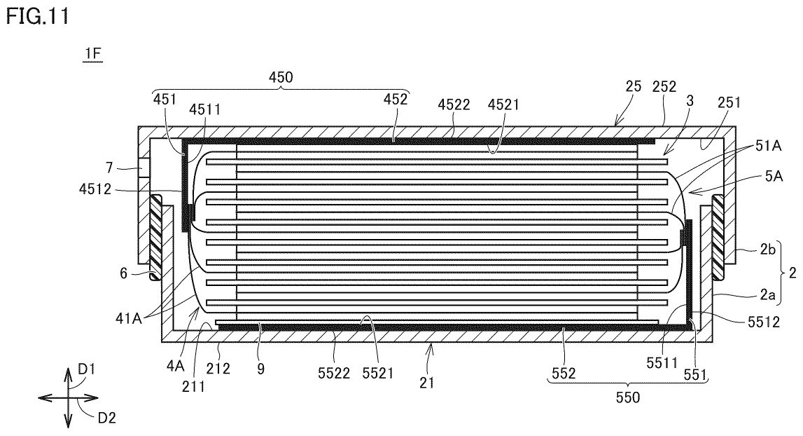

FIG. 11 is a diagram illustrating Variation 8 of battery cell 1. As shown in FIG. 11, a battery cell 1F includes exterior case 2, stacked electrode assembly 3, a positive-current collector unit 4A, a negative-current collector unit 5A, and insulating material 6. Battery cell 1F differs from battery cell 1 in that the battery cell 1F includes positive-current collector unit 4A and negative-current collector unit 5A, while battery cell 1 includes positive-current collector unit 4 and negative-current collector unit 5.

Positive-current collector unit 4A includes multiple current-collector foils 41A and an L-shaped positive plate 450. Positive plate 450 has a part 451 extending in D1 direction, and a part 452 that continues to part 451 and extends in parallel to top 25 between top 25 and stacked electrode assembly 3.

Part 451 has an inner side surface 4511 on the stacked electrode assembly 3 side and an outer side surface 4512 opposite the inner side surface 4511. Part 452 has an inner side surface 4521 on the stacked electrode assembly 3 side and an outer side surface 4522 opposite the inner side surface 4521. Inner side surface 4521 is in contact with top-side positive electrode 31. Outer side surface 4522 is in contact with top 25 of exterior case 2. Specifically, outer side surface 4522 is in contact with inner wall surface 251 of top 25.

In this example, current-collector foil 41A and current-collector foil 311 of positive electrode 31 are one piece of foil. Current-collector foils 41A are collected and welded to part 451 of positive plate 450. Specifically, current-collector foils 41A are welded to inner side surface 4511 of part 451.

Negative-current collector unit 5A includes multiple current-collector foils 51A and an L-shaped negative plate 550. Negative plate 550 has a part 551 extending in D1 direction, and a part 552 that continues to part 551 and extends in parallel to bottom 21 between bottom 21 and stacked electrode assembly 3.

Part 551 has an inner side surface 5511 on the stacked electrode assembly 3 side and an outer side surface 5512 opposite the inner side surface 5511. Part 552 has an inner side surface 5521 on the stacked electrode assembly 3 side and an outer side surface 5512 opposite the inner side surface 5521. Inner side surface 5521 is in contact with insulating sheet 9. Outer side surface 5512 is in contact with bottom 21 of exterior case 2. Specifically, outer side surface 5512 is in contact with inner wall surface 211 of bottom 21.

In this example, current-collector foil 51A and current-collector foil 321 of negative electrode 32 are one piece of foil. Current-collector foils 51A are collected and welded to part 551 of negative plate 550. Specifically, current-collector foils 51A are welded to inner side surface 5511 of part 551.

According to the above configuration, for example, size reduction of battery cell 1F, as compared to battery cell 1, can achieved by reducing a combined thickness of positive plate 450 and negative plate 550 to be less than the thickness of the overlaid current-collector foils 41A.

Furthermore, according to the above configuration, for example, the resistances at positive-current collector unit 4A and negative-current collector unit 5A can be reduced to be less than the resistances at positive-current collector unit 4 and negative-current collector unit 5 of battery cell 1 by increasing a combined thickness of positive plate 450 and negative plate 550 to be greater than the thickness of the overlaid current-collector foils 41A. Therefore, variations in current within the surface of negative-current collector unit 5A in contact with bottom 21 and the surface of positive-current collector unit 4A in contact with top 25 can be reduced. As a result, temperature distributions in part 452 and in part 552 can be made uniform.

Furthermore, according to the above configuration, for example, the resistances at positive-current collector unit 4A and negative-current collector unit 5A can be reduced to be less than the resistances at positive-current collector unit 4 and negative-current collector unit 5 of battery cell 1 by using metals whose electrical conductivities are higher than the electrical conductivities of current-collector foils 41A and 51A to form positive-current collector unit 4A and negative-current collector unit 5A. Therefore, variations in current can be reduced in the surface of negative-current collector unit 5A in contact with bottom 21 and the surface of positive-current collector unit 4A in contact with top 25. As a result, temperature distributions in part 452 and part 552 can be made uniform.

Preferably, the surfaces of the current-collector foils 41A are insulated. With such a configuration, a short circuit can be prevented from occurring between current-collector foils 41A and main unit 2a of exterior case 2. Similarly, preferably, the surfaces of current-collector foils 51A are insulated. With such a configuration, a short circuit can be prevented from occurring between current-collector foils 51A and cover 2b of exterior case 2.

### Embodiment 2

Embodiment 1 has been described in which the electrolyte solution is injected in exterior case 2 and stacked electrode assembly 3 includes separator 33. In the present embodiment, the battery cell is an all-solid-state battery which requires no electrolyte solution.

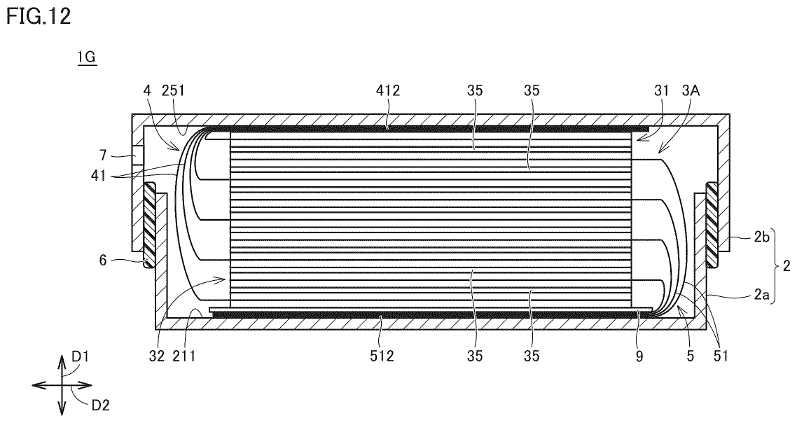

FIG. 12 is a diagram showing a battery cell 1G according to the present embodiment. As shown in FIG. 12, battery cell 1G includes an exterior case 2, a stacked electrode assembly 3A, a positive-current collector unit 4, a negative-current collector unit 5, an insulating material 6, and an insulating sheet 9. Battery cell 1G differs from battery cell 1 in that the battery cell 1G includes stacked electrode assembly 3A, instead of stacked electrode assembly 3. In the following, a configuration of battery cell 1G will be described, focusing on differences from battery cell 1.

Stacked electrode assembly 3A includes multiple positive electrodes 31, multiple negative electrodes 32, and multiple separator layers 35. Stacked electrode assembly 3A differs from stacked electrode assembly 3 in that the stacked electrode assembly 3A has separator layers 35, instead of the separators 33. Each separator layer 35 includes a solid electrolyte and a binder.

In stacked electrode assembly 3A, positive electrodes 31 and negative electrodes 32 are alternately stacked in D1 direction via separator layers 35. In other words, stacked electrode assembly 3A has separator layer 35 between positive electrode 31 and negative electrode 32. Note that, similarly to stacked electrode assembly 3, a constraint force (a pressure) in D1 direction is applied by a cover 2b and a main unit 2a to stacked electrode assembly 3A.

Since battery cell 1G requires no injection of the electrolyte solution in exterior case 2, battery cell 1G is easy to manufacture, as compared to battery cell 1. Furthermore, battery cell 1G yields the same advantages effects as those of battery cell 1 according to Embodiment 1. Moreover, the variations of Embodiment 1 described above are applicable to battery cell 1G, as appropriate.

### Embodiment 31

Embodiment 2 has been described with reference to battery cell 1G including one stacked electrode assembly 3A. In the present embodiment, a battery cell includes multiple stacked electrode assemblies 3A.

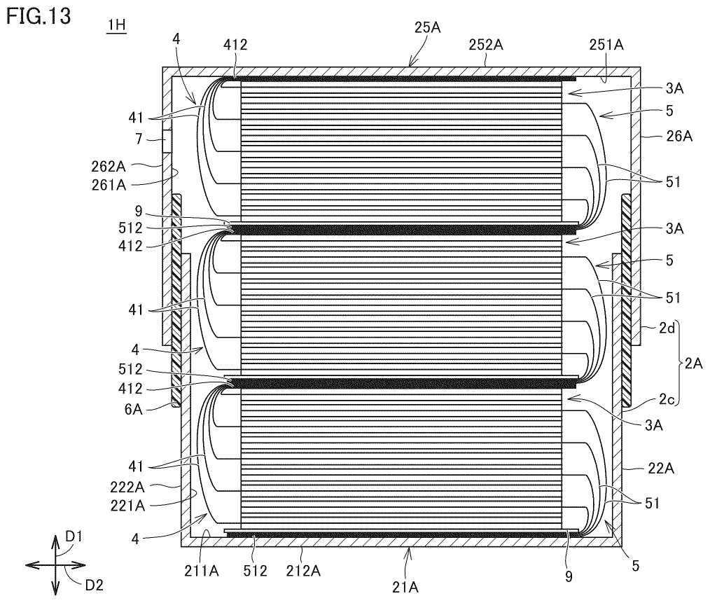

FIG. 13 is a diagram showing a battery cell 1H according to the present embodiment. As shown in FIG. 13, battery cell 1H includes an exterior case 2A, three stacked electrode assemblies 3A, three positive-current collector units 4, three negative-current collector units 5, and an insulating material 6A. The three stacked electrode assemblies 3A are aligned in D1 direction. The three positive-current collector units 4 and the three negative-current collector units 5 are also aligned in D1 direction. Note that the number of stacked electrode assemblies 3A, the number of positive-current collector units 4, and the number of negative-current collector units 5 are not limited to three and may be at least two.

Exterior case 2A includes a main unit 2c and a cover 2d. Main unit 2c has a bottom 21A and a side wall 22A extending upward from the outer periphery of bottom 21A. Cover 2d has a top 25A opposite the bottom 21A and a side wall 26A extending downward from the outer periphery of top 25A.

Cover 2d is put on main unit 2c to cover a portion of side wall 22A of main unit 2c. Side wall 22A and side wall 26A partially overlap as viewed from D2 direction perpendicular to D1 direction which is the direction in which the stacked electrode assemblies 3A are stacked.

As with exterior case 2, exterior case 2A has, typically, a generally parallelepiped shape. However, the shape of exterior case 2A is not limited thereto.

Bottom 21A of main unit 2c has an inner wall surface 211A and an outer wall surface 212A. Side wall 22A of main unit 2c has an inner wall surface 221A and an outer wall surface 222A. Inner wall surface 211A and inner wall surface 221A are wall surfaces on the stacked electrode assembly 3A side.

Bottom 21A has the same function as bottom 21 according to Embodiment 1. Bottom 21A has the same shape as bottom 21. Side wall 22A has the same function as side wall 22 according to Embodiment 1. Since multiple stacked electrode assemblies 3A are accommodated within exterior case 2A, the length of side wall 22A in D1 direction is longer than the length of side wall 22 in D1 direction.

Top 25A of cover 2d has an inner wall surface 251A and an outer wall surface 252A. Side wall 26A of cover 2d has an inner wall surface 261A and an outer wall surface 262A. Inner wall surface 251A and inner wall surface 261A are wall surfaces on the stacked electrode assembly 3A side. Inner wall surface 251A is opposite the inner wall surface 211A of bottom 21A.

Top 25A has the same function as top 25 according to Embodiment 1. Top 25A has the same shape as top 25. Side wall 26A has the same function as side wall 26 according to Embodiment 1. Since multiple stacked electrode assemblies 3A are accommodated within exterior case 2A, the length of side wall 26A in D1 direction is longer than the length of side wall 26 in D1 direction.

There is a gap between side wall 22A of main unit 2c and side wall 26A of cover 2d. Specifically, there is a gap between outer wall surface 222A of side wall 22A and inner wall surface 261A of side wall 26A. More specifically, a portion of outer wall surface 222 of main unit 2a and a portion of inner wall surface 261 of cover 2b are opposite to each other.

Insulating material 6A is loaded between side wall 22 and side wall 26. Insulating material 6A is loaded between outer wall surface 222A and inner wall surface 261A. Insulating material 6A is loaded in a region (gap) where outer wall surface 222A and inner wall surface 261A oppose to each other. Insulating material 6A insulates main unit 2c and cover 2d from each other. Cover 2d is secured to main unit 2c by insulating material 6A. Insulating material 6A restricts the movement of cover 2d relative to main unit 2c in D1 direction, D2 direction, and D3 direction.

Insulating material 6A has the same material as insulating material 6 according to Embodiment 1. Note that, in this example, the length of insulating material 6A in D1 direction is longer than the length of insulating material 6 in D1 direction. Similarly to cover 2b according to Embodiment 1, cover 2d is provided with a gas-draining 7.

In the following, for convenience of illustration, stacked electrode assembly 3A on the top 25 side are also be referred to as a “top-side stacked electrode assembly 3A.” Stacked electrode assembly 3A on the bottom 21 side will also be referred to as a “bottom-side stacked electrode assembly 3A.” Stacked electrode assembly 3A between top-side stacked electrode assembly 3A and bottom-side stacked electrode assembly 3A will also be referred to as an “intermediate stacked electrode assembly 3A.”

Similarly, positive-current collector unit 4 and negative-current collector unit 5 that are connected to top-side stacked electrode assembly 3A will also be referred to as a “top-side positive-current collector unit 4” and a “top-side negative-current collector unit 5,” respectively. Similarly, positive-current collector unit 4 and negative-current collector unit 5 that are connected to intermediate stacked electrode assembly 3A will also be referred to as an “intermediate positive-current collector unit 4” and an “intermediate negative-current collector unit 5,” respectively. Positive-current collector unit 4 and negative-current collector unit 5 that are connected to bottom-side stacked electrode assembly 3A will also be referred to as a “bottom-side positive-current collector unit 4” and a “bottom-side negative-current collector unit 5,” respectively.

In battery cell 1H, parts 412 of current-collector foils 41 in top-side positive-current collector unit 4 are connected to top 25A of cover 2d. Parts 512 of current-collector foils 51 in top-side negative-current collector unit 5 and parts 412 of current-collector foils 41 in intermediate positive-current collector unit 4 overlap on top of the other so as to be in contact with each other in D1 direction. Similarly, parts 512 of current-collector foils 51 in intermediate negative-current collector unit 5 and parts 412 of current-collector foils 41 in the bottom-side positive-current collector unit 4 overlap on top of the other so as to be in contact with each other in D1 direction. Parts 512 of current-collector foils 51 in the bottom-side negative-current collector unit 5 are connected to bottom 21A of main unit 2c.

Since stacked electrode assembly 3A has separator layers 35, instead of separators 33, stacked electrode assembly 3A can be subjected to discharge and charge tests prior to be accommodated into exterior case 2A. Due to this, only stacked electrode assemblies 3A that are determined to be non-defective are accommodated in exterior case 2A, thereby ensuring the quality of battery cell 1H. Furthermore, battery cell 1H yields the same advantages effects as those of battery cell 1 according to Embodiment 1. Moreover, the variations of Embodiment 1 described above are also applicable to battery cell 1H, as appropriate.

Battery cell 1H includes multiple stacked electrode assemblies 3A. Therefore, battery cell 1H can exhibit performance equivalent to or better than battery cell 1 even though the number of positive electrodes 31 and negative electrodes 32 included in each stacked electrode assembly 3A is reduced to be less than the number of stacked electrode assemblies 3 included in battery cell 1. Furthermore, since the number of positive electrodes 31 and negative electrodes 32 included in stacked electrode assembly 3A can be reduced as the above, the rejection rate of stacked electrode assemblies 3A can be lowered.

### Embodiment 4

Embodiments 1 to 3 have been described with reference to battery cells 1 and 1A to 1H including stacked electrode assemblies 3 and 3A. In the present embodiment, a battery cell includes a wound electrode assembly.

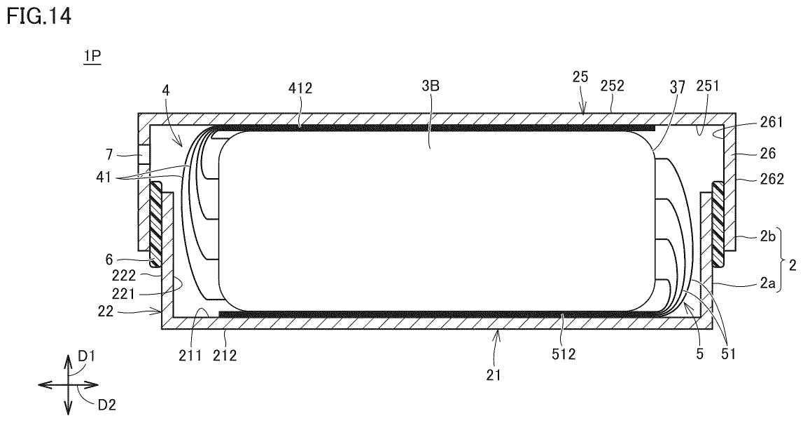

FIG. 14 is a diagram showing a battery cell 1P according to the present embodiment. As shown in FIG. 14, battery cell 1P includes an exterior case 2, a wound electrode assembly 3B, a positive-current collector unit 4, and a negative-current collector unit 5.

Battery cell 1P differs from battery cells 1 and 1A to 1H according to Embodiments 1 to 3 in that the battery cell 1P includes wound electrode assembly 3B, instead of stacked electrode assemblies 3 and 3A. Furthermore, battery cell 1P differs from battery cells 1 and 1A to 1H according to Embodiments 1 to 3 in that the battery cell 1P does not include insulating sheet 9.

Wound electrode assembly 3B has an insulative outer body 37. Wound electrode assembly 3B has a winding axis extending in D3 direction (see FIG. 6) perpendicular to D1 direction and D2 direction, and is configured of a stack including a band positive electrode, a band negative electrode, and a band separator being wound in a spiral shape about the winding axis. Specifically, wound electrode assembly 3B includes the stack wound in the spiral shape and an electrolyte solution accommodated within outer body 37.

In wound electrode assembly 3B, the positive electrodes and the negative electrodes are alternately stacked from the winding axis toward the outer periphery side. Therefore, it may be said that, in wound electrode assembly 3B, the positive electrodes and the negative electrodes are alternately stacked at least in D1 direction.

In this example, four current-collector foils 41 are connected to the band positive electrode. Each current-collector foil 41 functions as a positive tab of wound electrode assembly 3B. Similarly, four current-collector foils 51 are connected to the band negative electrode. Each current-collector foil 51 functions as a negative tab of wound electrode assembly 3B.

Battery cell 1H having the above configuration yields the same advantages effects as those of battery cell 1 according to Embodiment 1. Moreover, the variations of Embodiment 1 described above are applicable to battery cell 1G, as appropriate.

### Embodiment 51

Embodiments 1 to 3 have been described with reference to stacked electrode assemblies 3 and 3A as monopolar-type electrode assemblies. The present embodiment will be described with reference to a stacked electrode assembly being of a bipolar type.

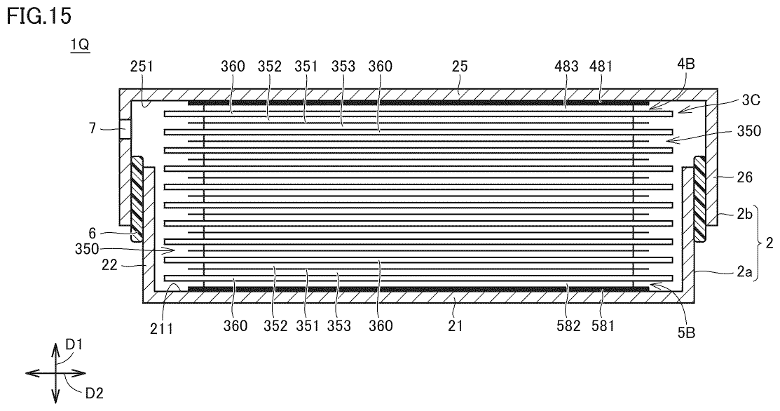

FIG. 15 is a diagram showing a battery cell 1Q according to the present embodiment. As shown in FIG. 15, battery cell 1Q includes an exterior case 2, a stacked electrode assembly 3C, a positive-current collector unit 4B, and a negative-current collector unit 5B. Battery cell 1Q differs from battery cells 1 and 1A to 1H according to Embodiments 1 to 3 in that the battery cell 1Q includes stacked electrode assembly 3C, instead of stacked electrode assemblies 3 and 3A.

Furthermore, battery cell 1Q differs from battery cells 1 and 1A to 1H according to Embodiments 1 to 3 in that the battery cell 1Q includes positive-current collector unit 4B and negative-current collector unit 5B, instead of positive-current collector units 4 and 4A and negative-current collector units 5 and 5B. Battery cell 1Q differs from battery cells 1 and 1A to 1H according to Embodiments 1 to 3 in that the battery cell 1Q does not include insulating sheet 9.

Similarly to stacked electrode assembly 3, a constraint force (a pressure) in D1 direction is applied by a cover 2b and a main unit 2a to stacked electrode assembly 3C. An electrolyte solution is injected in exterior case 2.

Stacked electrode assembly 3C is a bipolar-type electrode assembly. Stacked electrode assembly 3C includes multiple bipolar electrodes 350 and multiple separators 360. In stacked electrode assembly 3C, bipolar electrodes 350 are stacked in D1 direction via separators 360.

Each bipolar electrode 350 has a current-collector foil 351, a positive electrode 352, and a negative electrode 353. Positive electrode 352 is formed on one surface of current-collector foil 351. Negative electrode 353 is formed on the other surface of current-collector foil 351. In this example, positive electrode 352 is formed on the cover 2b-side surface of current-collector foil 351. Positive electrode 352 is formed on the main unit 2a-side surface of current-collector foil 351.

Positive-current collector unit 4B and negative-current collector unit 5B function as current collector units for stacked electrode assembly 3C. Specifically, positive-current collector unit 4B and negative-current collector unit 5B function as terminating electrodes of stacked electrode assembly 3C.

Positive-current collector unit 4B is stacked on bipolar electrode 350 on the top 25 side in D1 direction, via separator 360. Furthermore, positive-current collector unit 4B is in contact with inner wall surface 251 of top 25. Negative-current collector unit 5B is stacked on bipolar electrode 350 on the bottom 21 side in D1 direction, via separator 360. Furthermore, negative-current collector unit 5B is in contact with inner wall surface 211 of bottom 21.

Specifically, positive-current collector unit 4B has a current-collector foil 481 and a negative electrode 483. One surface of current-collector foil 481 is in contact with inner wall surface 251 of top 25. Negative electrode 483 is in contact with the other surface of current-collector foil 481. Negative electrode 483 of positive-current collector unit 4B and positive electrode 352 of bipolar electrode 350 adjacent to positive-current collector unit 4B are opposite to each other via separator 360.

Negative-current collector unit 5B has a current-collector foil 581 and a positive electrode 582. One surface of current-collector foil 581 is in contact with inner wall surface 211 of bottom 21. Positive electrode 582 is formed on the other surface of current-collector foil 581. Positive electrode 582 of negative-current collector unit 5B and negative electrode 353 of bipolar electrode 350 adjacent to negative-current collector unit 5B are opposite to each other via separator 360.

As described above, battery cell 1Q includes: (i) stacked electrode assembly 3C in which negative electrodes 353 and positive electrodes 352 are alternately stacked in D1 direction; (ii) negative-current collector unit 5B connected to one negative electrode 353; (iii) positive-current collector unit 4B connected to one positive electrode 352; (iv) and exterior case 2 accommodating stacked electrode assembly 3C, negative-current collector unit 5B, and positive-current collector unit 4B. Exterior case 2 includes main unit 2a and cover 2b. Current-collector foil 581 of negative-current collector unit 5B is located between main unit 2a and stacked electrode assembly 3C in D1 direction, and is electrically connected to main unit 2a. Current-collector foil 481 of positive-current collector unit 4B is located between cover 2b and stacked electrode assembly 3C in D1 direction, and is electrically connected to cover 2b.

With such a configuration, negative-current collector unit 5B can allow main unit 2a of exterior case 2 to function as a negative terminal. Positive-current collector unit 4B can allow cover 2b of exterior case 2 to function as a positive terminal.

Furthermore, negative-current collector unit 5B connects to main unit 2a through current-collector foil 581 that is located between main unit 2a and stacked electrode assembly 3C in D1 direction. Positive-current collector unit 4B connects to cover 2b through current-collector foil 481 that is located between cover 2b and stacked electrode assembly 3C in D1 direction. Accordingly, positive-current collector unit 4B and negative-current collector unit 5B, while being apart from each other in D1 direction, can be brought into contact with exterior case 2.

Therefore, according to battery cell 1Q, the volumetric efficiency can be increased, as compared to the battery cell configuration in which only one of the negative-current collector unit and the positive-current collector unit are in contact with the exterior case.

### Embodiment 61

The present embodiment will be described with reference to a battery cell having a stacked electrode assembly different from stacked electrode assembly 3 according to Embodiment 1.

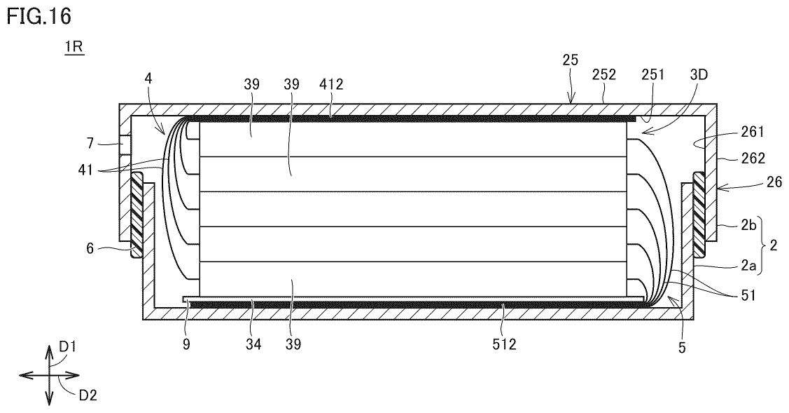

FIG. 16 is a diagram showing a battery cell 1R according to the present embodiment. As shown in FIG. 16, battery cell 1R includes an exterior case 2, a stacked electrode assembly 3D, a positive-current collector unit 4, a negative-current collector unit 5, an insulating material 6, and an insulating sheet 9. Stacked electrode assembly 3D includes multiple electrode units 39.

Electrode units 39 are stacked in D1 direction. Electrode unit 39 are connected to positive-current collector unit 4 and negative-current collector unit 5. Insulating sheet 9 is disposed between electrode unit 39 on the main unit 2a side and negative-current collector unit 5. Specifically, insulating sheet 9 is disposed between electrode unit 39 on the main unit 2a side and part 512 (see FIG. 2) of negative-current collector unit 5.

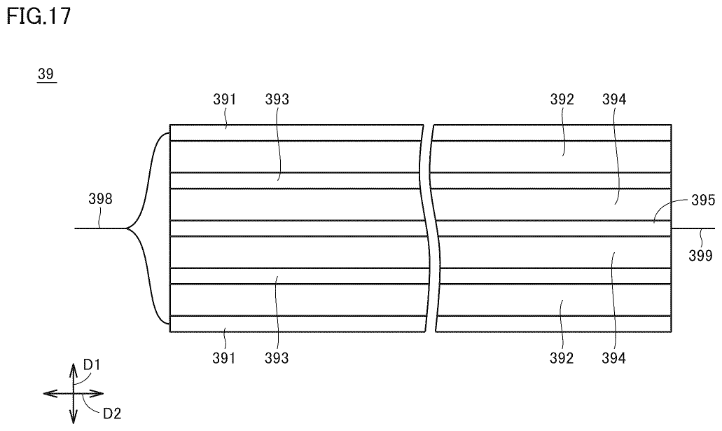

FIG. 17 is a diagram showing electrode unit 39. As shown in FIG. 17, electrode unit 39 has multiple current-collector foils 391 for positive electrode, multiple positive electrode layers 392, multiple separator layers 393, multiple negative electrode layers 394, and multiple current-collector foils 395 for negative electrode. In electrode unit 39, current-collector foil 391, positive electrode layer 392, separator layer 393, negative electrode layer 394, and current-collector foil 395 are stacked in the listed order in D1 direction. Separator layer 393 includes a solid electrolyte and a binder.

In this example, a current-collector foil 398 functioning as a tab of electrode unit 39 is connected to two current-collector foils 391. A current-collector foil 399 functioning as a tab of electrode unit 39 is connected to one current-collector foil 395. The current-collector foil 398 is connected to current-collector foil 41 (FIG. 16). The current-collector foil 399 is connected to current-collector foil 51 (FIG. 16).

Battery cell 1R having such a configuration yields the same advantages effects as those of battery cell 1 according to Embodiment 1. Moreover, the variations of Embodiment 1 described above are applicable to battery cell 1G, as appropriate.

While the embodiments according to the present disclosure have been described above, the presently disclosed embodiments should be considered in all aspects illustrative and not restrictive. The scope of the present disclosure is defined by the appended claims. All changes which come within the meaning and range of equivalency of the appended claims are to be embraced within their scopes.

What is claimed is:

1. A battery cell, comprising:
an electrode assembly in which positive electrodes and negative electrodes are alternately stacked in a first direction;
a first current collector unit connected to at least one of the positive electrodes;
a second current collector unit connected to at least one of the negative electrodes; and
an exterior case accommodating the electrode assembly, the first current collector unit, and the second current collector unit, wherein
the exterior case includes a first casing body and a second casing body,
at least a portion of the first current collector unit is located between the first casing body and the electrode assembly in the first direction and is electrically connected to the first casing body, and
at least a portion of the second current collector unit is located between the second casing body and the electrode assembly in the first direction, and is electrically connected to the second casing body.

2. The battery cell according to claim 1, wherein
the first casing body has
a first base connected to the at least a portion of the first current collector unit, and
a first side wall extending from an outer periphery of the first base in a first orientation of the first direction, the first orientation pointing toward the electrode assembly, wherein
the second casing body has
a second base opposite the first base and connected to the at least a portion of the second current collector unit, and
a second side wall extending from an outer periphery of the second base in a second orientation opposite the first orientation, wherein
the first side wall and the second side wall partially overlap, as viewed in a second direction perpendicular to the first direction.

3. The battery cell according to claim 2, wherein
an insulating material is loaded between the first side wall and the second side wall.

4. The battery according to claim 2, wherein
the first current collector unit includes a plurality of first current-collector foils which are each connected to a different positive electrode among the positive electrodes, wherein
the first current-collector foils each have
a first part extending from the positive electrode in a direction toward the first base, and
a second part which continues to the first part and extends in parallel to the first base between the first base and the electrode assembly, wherein
the second part is electrically connected to the first casing body and opposite the negative electrode in the first direction, and
the second part and the negative electrode opposite the second part in the first direction are insulated from each other.

5. The battery according to claim 2, wherein
the second current collector unit includes a plurality of second current-collector foils which are each connected to a different negative electrode among the negative electrodes, wherein
the second current-collector foils each have
a first part extending from the negative electrode in a direction toward the second base, and
a second part which continues to the first part and extends in parallel to the second base between the second base and the electrode assembly, wherein
the second part is electrically connected to the second casing body and opposite the positive electrode in the first direction, and
the second part and the positive electrode opposite the second part in the first direction are insulated from each other.

6. The battery cell according to claim 1, wherein
the electrode assembly further includes a separator layer between the positive electrode and the negative electrode, the separator layer including a solid electrolyte.

7. The battery cell according to claim 1, wherein
one of the first casing body and the second casing body is a main unit of the exterior case and the other one of the first casing body and the second casing body is a cover of the exterior case.

8. A battery module, comprising
a plurality of battery cells, including the battery cell according to claim 1, wherein
the plurality of battery cells are stacked in the first direction.

9. A battery cell manufacturing method, comprising:
mounting a battery cell having: an electrode assembly in which positive electrodes and negative electrodes are alternately stacked in a first direction; a first current collector unit connected to at least one of the positive electrodes; and a second current collector unit connected to at least one of the negative electrodes so that the first current collector unit is in contact with a first casing body of an exterior case of the battery cell in the first direction;
moving the first casing body and a second casing body of the exterior case relative to each other so that the second current collector unit is in contact with the second casing body in the first direction; and
securing one of the first casing body and the second casing body to the other one of the first casing body and the second casing body.

10. The battery cell manufacturing method according to claim 9, wherein
the first casing body has
a first base connected to the at least a portion of the first current collector unit, and
a first side wall extending from an outer periphery of the first base in a first orientation of the first direction, the first orientation pointing toward the electrode assembly, wherein
the second casing body has
a second base opposite the first base and connected to the at least a portion of the second current collector unit, and
a second side wall extending from an outer periphery of the second base in a second orientation opposite the first orientation, wherein
the first side wall and the second side wall partially overlap, as viewed in a second direction perpendicular to the first direction,
the battery cell manufacturing method further comprising loading an insulating material between the first side wall and the second side wall.
